(19) United States
(12) Patent Application Publication
(10) Pub. No.: US 2008/0127652 A1
(43) Pub. Date: Jun. 5, 2008

(54) Heat Shield Element

(76) Inventor: Heinrich Putz, Much (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/793,195

(22) PCT Filed: Dec. 15, 2005
(86) PCT No.: PCT/EP05/56814

§ 371 Date: Jun. 14, 2007

(30) Foreign Application Priority Data
Dec. 16, 2004 (EP) 04029874.7

(51) Int. Cl. F02C 1/00; F02G 3/00; F28D 15/00

(52) U.S. Cl. 60/752; 60/266; 165/104.11

(57) ABSTRACT

There is described a heat shield element comprising a wall that is provided with a hot face which can be impinged upon by a hot medium and a cold face located opposite the hot face. The heat shield element further comprises a coolant distribution system which is assigned to the cold face. In order to convectively cool the heat shield element in a particularly effective manner, a plurality of cooling ducts which extend along the hot face are provided within the wall. Said cooling ducts are fluidically connected to the distribution system such that the coolant can be distributed to the individual cooling ducts with the aid of the distribution system. The convectively cooled heat shield element can be used in a particularly advantageous fashion for the heat-resistant lining of a combustion chamber, especially a combustion chamber of a gas turbine system.

The invention relates to a heat shield element comprising a wall that has a hot face to which a hot medium can be applied and a cold face disposed opposite the hot face, and comprising a cooling medium distribution system assigned to the cold face.

In a fluid acceleration machine, effective work is obtained by the expansion of a flowing hot medium, e.g. hot gas. With a view to increasing the efficiency of a fluid acceleration machine it is attempted inter alia to heat the hot gas to as high a temperature as possible, although this leads to the components that are directly exposed to the hot gas being subjected to an extremely severe thermal stress. For this reason it is necessary to design said components to be as temperature-resistant as possible so that they possess sufficient strength at very high temperatures of the hot gases. On the one hand, very high temperature resistant materials such as, for example, ceramics are suitable for this purpose. The disadvantage of these materials lies not only in their extreme brittleness but also in their unfavorable heat and temperature conductivity. Very high temperature resistant metal alloys based on iron, chromium, nickel and cobalt are suitable as an alternative to ceramic materials. However, since the temperature at which very high temperature resistant metal alloys can be used is significantly below the maximum temperature at which ceramic materials can be used, it is necessary to cool metallic heat shields which are in contact with a flowing hot medium.

In a gas turbine, which is an example of a fluid acceleration machine, the cooling medium required for cooling for typically one compressor positioned upstream of the turbine is taken in the form of compressor extraction air. In order to keep the efficiency of the thermodynamic process as high as possible in spite of the cooling air extraction from the compressor, intensive efforts are being made to find cooling concepts which ensure the most efficient possible use of cooling medium.

One method of cooling is proposed in DE 29714742 U1. In this publication a heat shield configuration comprising a plurality of heat shield components is described. The heat shield components are secured to a supporting structure and each heat shield component is aligned along a main axis which is disposed essentially vertically relative to said supporting structure. A heat shield component has a hot wall running parallel to the supporting structure and exposed to a hot gas, said hot wall adjoining an interior space. An inlet passage for cooling fluid aligned along the main axis widens out in the direction of the hot gas wall into the interior space. It is closed off by means of a cover wall which has openings to allow cooling fluid to flow through. The cover wall is aligned essentially parallel to the hot gas wall and extends over the latter's entire extent. The cooling fluid flowing under high pressure through the openings strikes the inner surface vertically and effects an impingement cooling there. From the inner surface the heated cooling fluid emerges from the interior space of the heat shield component through an outlet passage running parallel to the main axis. Connected to the outlet passage is a discharge passage which can be embodied, for example, as a tube. The discharge passage preferably leads to a burner of the gas turbine, where the heated cooling air assists the combustion process. DE 29714742 U1 is therefore characterized by a closed-circuit cooling concept using an impingement cooling device.

DE 196 43 715 A1 has a cooled flame tube having an outer and an inner wall cladding for a combustion chamber, wherein a vaporous cooling medium flows through the wall cladding. In this arrangement the wall cladding consists of rows of adjoining segments which are provided with a plurality of drilled passage holes. At their ends the segments are connected to a collector for the vaporous cooling medium. The cooling medium now travels from the collectors through the drilled passage holes to the flame tube. The cooling method is a closed-circuit cooling cycle in which water vapor is provided as the cooling medium.

EP 1 005 620 B1 also discloses an impingement cooling device for cooling the combustion chamber wall of a gas turbine. The entire combustion chamber wall is lined with heat shield components which take the form of hollow tiles and said heat shield components are secured to a supporting structure of the combustion chamber. Each heat shield component has a hollow body, the base side of which can be exposed to a hot gas. Disposed in the hollow body is a further small hollow body as an insert. On its base side said insert has passage openings, with the result that an impingement cooling device is present. In this way an interior space is formed which is delimited by the insert and the supporting structure. The supporting structure has one or more inlet passages through which cooling fluid can reach the interior space. The supporting structure furthermore has outlet passages from the intermediate space which is delimited by the insert, the hollow body and the supporting structure. In order to provide impingement cooling of the base side, cooling fluid flows under high pressure through the inlet passages into the interior space of the impingement cooling insert and passes through the plurality of impingement cooling openings into the intermediate space, in the process striking the inner surface of the base side. The cooling fluid, which has been heated after the impingement cooling, is discharged from the intermediate space through the outlet passages. Thus, in EP 1 005 620 B1 too, the cooling fluid is directed in a closed-circuit cooling cycle.

The prior art presented in the above-cited publications has two great disadvantages. On the one hand the impingement cooling devices for cooling the combustion chamber wall of a gas turbine proposed in DE 97 02 168 and EP 1 005 620 B1 require a comparatively large amount of cooling air which is taken from the compressor, and that leads to a poorer efficiency of the thermodynamic process. On the other hand, an impingement cooling process results in uneven temperature distribution on the wall requiring cooling, since the heat is efficiently dissipated only locally. This leads to temperature gradients and the material is exposed to very extreme thermomechanical stress. By proposing a few technical and constructional modifications the cited publications offer an improvement only in relation to the large amount of compressor extraction air. The heat shield elements described are designed in such a way that a low consumption of cooling air is guaranteed. This allows economical operation of the installation, albeit still subject to the condition that the cooling air is introduced into the heat shield element to be cooled under comparatively high pressure for the purpose of impingement cooling.

The object of the invention is to specify a heat shield element such that the described disadvantages of the prior art are overcome, wherein in particular a uniform cooling of the wall requiring cooling is made possible while at the same time insuring efficient use of cooling medium.

The object directed to the heat shield element is achieved according to the invention by means of a heat shield element comprising a wall which has a hot face to which a hot medium can be applied and a cold face disposed opposite the hot face, and comprising a cooling medium distribution system assigned to the cold face, wherein a plurality of cooling ducts running along the hot face are provided within the wall and said cooling ducts are fluidically connected to the distribution system.

The invention is based on the knowledge that the existing cooling concepts which are based on impingement cooling of the wall requiring to be cooled come up against the design and optimization limits in terms of consumption of cooling medium. The invention therefore takes a completely different approach to cooling the wall, wherein convective concepts are employed. It is also proposed for the first time here for the wall requiring cooling itself to be designed for efficient convective cooling, in that cooling ducts are provided within the wall. Each of said cooling ducts is supplied with cooling medium by means of the assigned distribution system, e.g. cooling air at a suitable pressure and temperature level as well as of mass flow rate.

The convective cooling which takes place in the cooling ducts during operation achieves a reduction in the temperature in the wall requiring cooling itself, even before the majority of the heat flow has reached the interior of the heat shield. With an impingement cooling method the heat is evacuated from the hollow interior of the heat shield element. In the present invention a very large amount of heat is evacuated at an earlier stage of the heat transfer by means of the ducts in the wall. In this way the temperature gradient between the hot face and the cold face of the wall requiring to be cooled is substantially reduced. The advantage of convective cooling which takes place already in the wall compared with impingement cooling or convective cooling in the interior space of the heat shield is that the temperature of the interior space is significantly lower than in the other cases and that is particular favorable for the components of the heat shield (bolts, seals, springs) which are not subjected to thermally stresses. The cooling medium is supplied via a feed duct. The cooling medium collects at the end of said feed duct and then flows into the distribution system. In this way, by means of a suitable pressure level of the cooling medium, it is possible to achieve impingement cooling of a part of the heat shield element already at the collecting point of the cooling medium in the feed duct, for example the area in which the retaining bolt is disposed. This is particularly advantageous since by this means the particularly critical areas in the heat shield element experience additional improved cooling. The cooling medium is also heated up.

The new concept which is disclosed in the present patent application overcomes both disadvantages from the prior art and ensures a much more efficient use of cooling medium. The advantages of a heat shield element designed according to this concept are that thanks to the predominantly convective cooling the amount of compressor extraction air in a gas turbine can be reduced even further compared to the above-discussed prior art. At the same time this type of cooling ensures a uniform temperature distribution in the wall of the heat shield element and by means of a cooling medium flow that is adjustable via the pressure level achieves the impingement cooling of the collecting point of the cooling medium in the feed duct. This results in an improvement in the cooling of the particularly critical areas.

Preferably the cooling ducts have an inlet and an outlet for the cooling medium. In this case two embodiments and the combination of both are possible. In the first embodiment, each of the cooling ducts has a respective inlet and a respective outlet. In the second embodiment there is provided a common inlet (or outlet) which is connected to or, as the case may be, fluidically communicates with a plurality of ducts.

The wall requiring cooling further preferably has a first side area and a second side area located opposite thereto such that the inlet of the cooling duct is disposed in the first side area and the outlet is disposed in the second side area. In this way the cooling medium can be routed via the distribution system into the first side area and enter via the inlet in the first side area into the wall requiring cooling. The cooling medium then emerges at the opposite side area and the result is a uniform cooling along and within the entire wall. On its way from the first side area to the second side area the cooling medium can absorb a correspondingly great amount of thermal energy due to the distance traveled in the cooling duct and the average residence time, which leads to a low demand for cooling medium. The length of the cooling ducts and consequently the length of the heat shield element are chosen such that all the temperature boundary conditions are complied with at the same time as achieving the greatest possible heating of the cooling medium, i.e. the heating of the cooling medium can be increased by variations in the length of the heat shield or wall up to the permissible limit.

In another preferred embodiment the inlet and the outlet of the cooling ducts are disposed in the first side area of the wall. In this embodiment the above-cited advantages are retained—the heat shield element is crossed by cooling ducts from the first side area to the second side area, thus ensuring a uniform temperature distribution at the wall requiring cooling and at the same time this embodiment enables a more efficient use of cooling medium. With this configuration, in which the inlet and outlet are disposed in the same side area of the wall, the cooling duct, and hence the cooling medium, completes a change in direction when flowing through the wall. In this way temperature gradients can be further reduced, since on average the heat evacuation is more uniform in a side area, e.g. only as far as the middle of the wall.

A further preferred feature of the heat shield element includes a cooling duct whose inlet is located in the first side area of the wall and makes at least one U-turn in the second side area of the wall such that during cooling ducts lying adjacent to one another can be flowed through in opposite directions, with the result that a counter flow of cooling medium can be generated in the wall. The principle here is that the permissible amount of heat which the cooling medium can absorb from the wall requiring cooling is not achieved by variations in the wall length, but instead, given a constant size of the heat shield element, the length of the duct is increased, resulting in at least one U-turn in the second side area.

A further preferred embodiment of this principle entails the use of a cooling duct which is serpentine in shape. This means more than one U-turn of the cooling duct and has a plurality of ducts arranged adjacent to one another in which a counter flow of cooling medium is generated. In this case the outlet of the cooling duct can be disposed either in the first or in the second side area.

Preferably the cooling ducts are disposed closer to the hot face than to the cold face of the wall requiring cooling. This embodiment leads to significantly improved heat transfer between the hot face of the wall and the cooling medium in the ducts. In this arrangement the total thickness of the wall is designed such that deformations and stresses are taken into account and overcome. Preferably the distance of the cooling ducts from the hot face amounts to between 20% and 40% of the wall thickness. A greater distance would adversely affect the heat transfer, while a smaller distance would lead to considerable deformations of the hot face of the wall.

Preferably the distribution system is mounted directly on the cold face of the wall requiring cooling. The cooling medium can enter the heat shield—e.g. in the assembled state on a combustion chamber wall with a supporting structure—by means of a sealed feed duct: in this case no leakages will occur in the system. This feed duct is formed e.g. in the supporting structure. In the assembled state of the heat shield element the feed duct leads into the distribution system itself and can also be regarded as a part of the distribution system. Via the distribution system on the cold face of the heat shield element the cooling medium reaches the first side area, where it enters the cooling ducts. The distribution system and the cooling ducts can be designed either for closed-circuit or for open-circuit cooling, although preferably open-circuit cooling is provided. In this embodiment the outlets of the cooling ducts are preferably mounted on the cold face such that cooling medium partially flows under the wall when emerging from the cooling ducts or, as the case may be, a sealing air effect is achieved. The pressure of the cooling medium is higher than the ambient pressure of the hot gases. This prevents hot gas penetrating into the heat shield element or attacking the supporting structure.

The heat shield element preferably consists of a high-temperature-resistant material, in particular a metal or metal alloy, e.g. high-temperature-resistant alloys based on iron, chromium, nickel and cobalt. The length of the heat shield element from the outer edge of the first side area to the outer edge of the second side area is preferably between 200 mm and 400 mm. With these dimensions a full-coverage lining of a wall requiring protection, e.g. a combustion chamber wall, can typically be achieved.

The heat shield element is used for cooling a hot gas conducting component, in particular a combustion chamber, preferably an annular combustion chamber of a gas turbine, which component has a supporting structure on which such heat shield elements are mounted. In this arrangement the heat shield element is preferably fixed to the supporting structure of the combustion chamber by means of a retaining bolt. The bolt is preferably located on the cold face of the wall requiring cooling, which is very advantageous during operation.

The supporting structure of the combustion chamber preferably has at least one feed duct so that cooling medium can be supplied to the heat shield element via the feed duct. In this arrangement the feed duct is incorporated into the supporting structure, e.g. as a drilled hole or as a plurality of drilled holes forming the feed duct. Said feed duct preferably leads into the distribution system. The feed duct is sealed against the environment in order to avoid leakages.

The combustion chamber on which the heat shield elements are mounted is preferably part of a gas turbine system. Said gas turbine system has a compressor from which cooling air as a cooling medium for cooling the combustion chamber can preferably be tapped. This compressor extraction air serves for cooling the heat shield elements.

The structure and the mode of operation of the heat shield elements will be explained in more detail with reference to the exemplary embodiments illustrated in the drawings. The drawings show, in some cases in a schematic and simplified form:

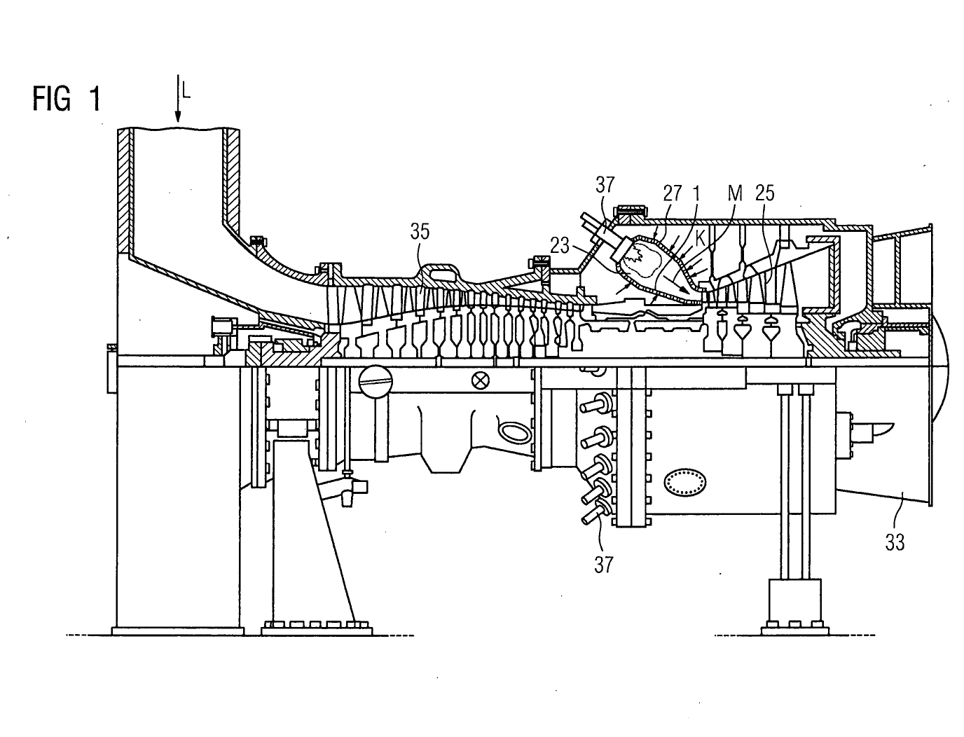

FIG. 1 a half-section through a gas turbine system comprising compressor, combustion chamber and turbine,

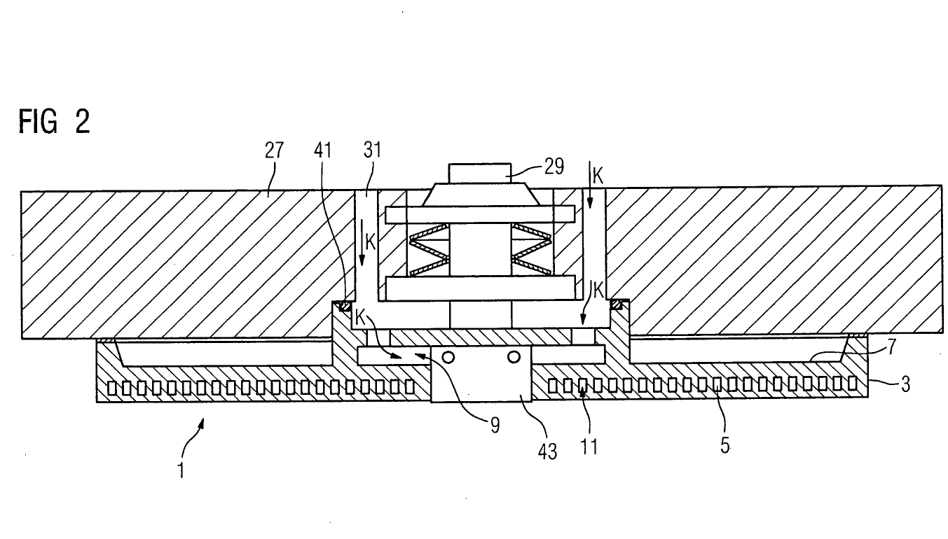

FIG. 2 a longitudinal section through the heat shield element,

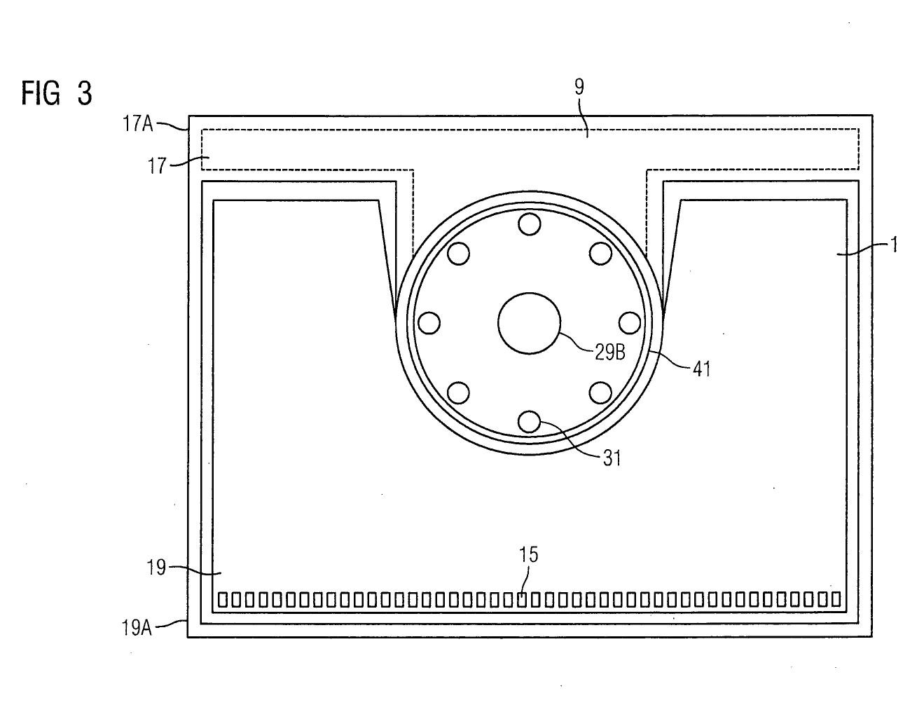

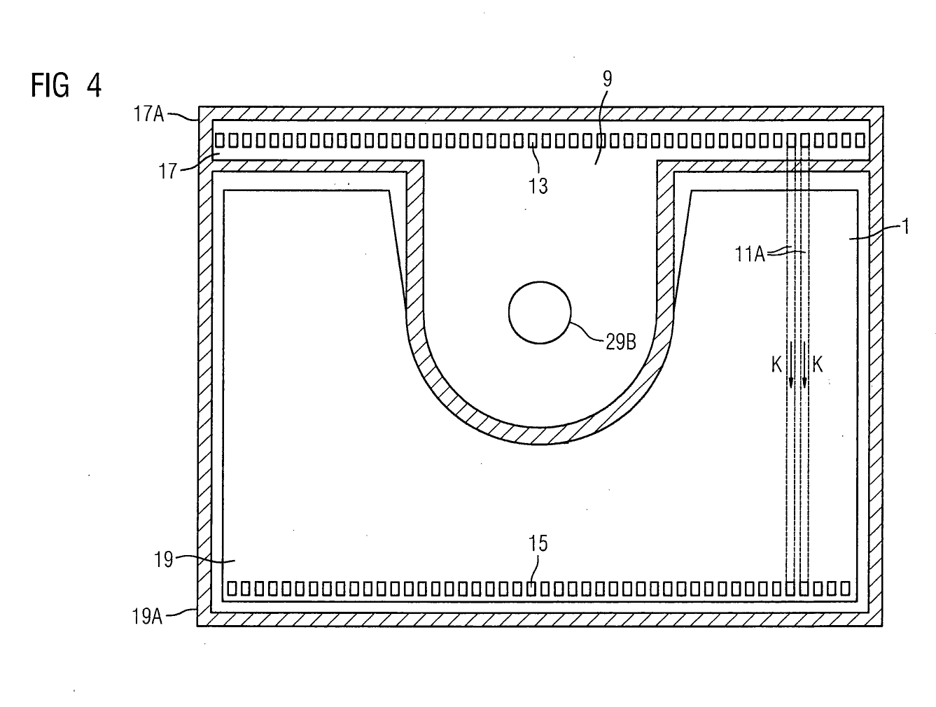

FIG. 3 a cross-section through the heat shield element according to FIG. 2, FIG. 4 a cross-section through a heat shield element according to FIG. 2, having a deeper section plane in relation to the wall requiring cooling than in FIG. 3,

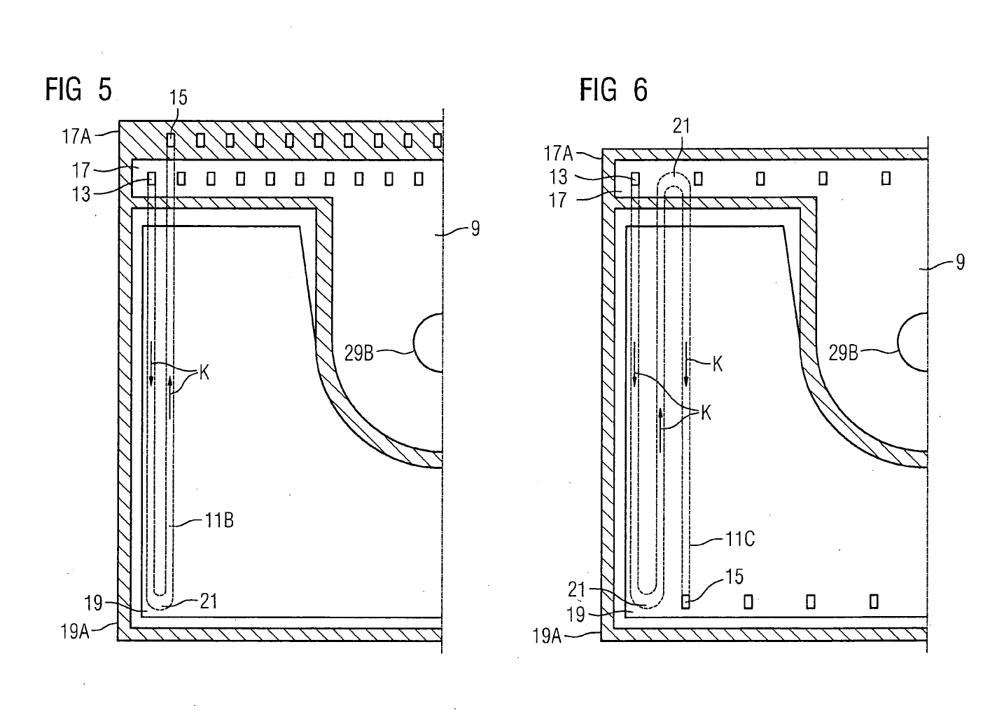

FIG. 5 a cross-section through a half of a heat shield element having cooling ducts, and

FIG. 6 a cross-section through a half of a heat shield element with an alternative embodiment of the cooling ducts compared to FIG. 5.

FIG. 1 shows a gas turbine system 33 which is represented partially sliced through lengthwise. The gas turbine system 33 has a compressor 35, an annular combustion chamber 23 having a plurality of burners 37 for a liquid or gaseous fuel material, as well as a gas turbine 25 for driving the compressor 35 and a generator which is not shown in FIG. 1. In this arrangement the entire combustion chamber wall is lined with heat shield elements 1 shown in greater detail in FIG. 2, or the heat shield elements 1 are mounted on a supporting structure 27 on the combustion chamber wall. During the operation of the gas turbine system 33, air L is drawn in from the environment. The air L is compressed in the compressor 35 and thereby partially heated. A small proportion of the air L is extracted from the compressor 35 and supplied as a cooling medium K to the heat shield elements 1; the greater part of the air L is supplied to the burners for combustion. In the combustion chamber 23, the greater part of the air L from the compressors 35 is merged with the liquid or gaseous combustion material and combusted. In the process there is produced the hot medium M, in particular hot gas, which drives the gas turbine 27. The hot gas M relaxes and cools in the gas turbine 27.

FIG. 2 shows in schematic form in a longitudinal section a heat shield element 1 which is mounted on the supporting structure 27. The heat shield element 1 is fixed to the supporting structure 27 by means of a retaining bolt 29. The heat shield element 1 has a wall 3. The wall 3 has a hot face 5 to which the hot medium M can be applied and a cold face 7 located opposite the hot face 5. Cooling ducts 11 run along the hot face 5 within the wall 3. A distribution system 9 for cooling medium K is assigned to the cold face 7; in the present case the distribution system 9 is directly mounted on the cold face 7 and is thus part of the heat shield element 1 itself. The distribution system 9 is fluidically connected to the cooling ducts 11 such that cooling medium K can be distributed via the distribution system 9 to the cooling ducts 11. In this arrangement cooling medium K, in particular cooling air L which is extracted from the compressors 35, is routed by means of the feed ducts 31 which are incorporated in the supporting structure 27 into the distribution system 9 and in this way reaches the space on the cold face 7 of the wall 3. The cooling medium K is introduced into the feed ducts 31 under high pressure. This pressure effects additional impingement cooling at the end of the feed ducts 31, i.e. where the cooling medium K flows into the distribution system 9. This results in an improved cooling of particularly critical areas, e.g. in the vicinity of the retaining bolt 29. The distribution system 9 ensures that the cooling medium K, which is still under high pressure, is introduced into the cooling ducts 11, where it leads to a particularly effective convective cooling of the wall 3 as a result of its flowing within the plurality of cooling ducts 11. In order to avoid leakages, the feed ducts 31 are sealed from the environment by means of seals 41 at the junctions between the heat shield element 1 and the supporting structure 27.

FIG. 3 shows a cross-section through the heat shield element according to FIG. 2 in which the distribution system 9 and the outlets 15 of the ducts 11 are represented in detail. The cooling medium K flows through the feed ducts 31 into the heat shield element 1. From there it passes through the distribution system 9, which in relation to the section plane shown in FIG. 3 extends deeper in the direction of the wall requiring cooling 3, and reaches the first side area 17 of the heat shield element 1. Disposed in the first side area 17 are the inlets (see FIG. 4) of the cooling ducts 11. The first side area 17 is also delimited by its outer edge 17A. The second side area 19 lies opposite the first side area 17 on the wall 3. The second side area 19 has an outer edge 19A. The cooling medium K, which flows within the cooling ducts 11 from the first side area 17 to the second side area 19, escapes from the heat shield element 1 through the outlets 15 of the cooling ducts 11. A retaining aperture 29B can also be seen in FIG. 3. The retaining aperture 29B is concentrically surrounded by a plurality of feed ducts 31 and consequently the latter are at an equal distance from the retaining aperture. The annular seal 41 is fitted around the feed ducts 31, thereby ensuring that the entire system of feed ducts 31 and the retaining bolt 29 which encompasses them is sealed off from the environment.

FIG. 4 shows a cross-section through a heat shield element 1 according to FIG. 2, with a deeper section plane in relation to the wall requiring cooling 3 than in FIG. 3. The distribution system 9 encompasses the retaining aperture 29B and is fluidically connected to the inlets 13 of the cooling ducts 11A. The inlets 13 are disposed in the first side area 17. The outlets 15 are disposed in the second side area 19. Thus, the cooling ducts 11A extend from the first side area 17 directly, in particular rectilinearly, to the second side area 19 along the wall requiring cooling 3. In this arrangement the cooling medium K generates a direct current of cooling medium K from the first side area 17 to the second side area 19, where the cooling medium K flows out from the heat shield element 1. The cooling medium K can be used further after the cooling function for the purpose of sealing against hot gases M in order to protect the supporting structure against a hot gas attack.

FIG. 5 shows a cross-section through a half of a heat shield element 1 having cooling ducts 11B which generate a counter flow of cooling medium K in the wall requiring cooling 3. In the second side area 19 close to the outer edge 19A, the cooling ducts 11B make a U-turn 21 in which the cooling medium K changes its direction and flows back in the direction of the first side area 17. In the present arrangement the outlets 15 of the cooling ducts 11B are located in the first side area 17 in a space separated off from the distribution system 9 and lie closer to the outer edge 17A than the inlets 13. In this exemplary embodiment, inlets 13 and outlets 15 are arranged offset relative to one another in the first side area 17. Cooling medium K is applied to the inlets 13 by the distribution system 9.

FIG. 6 shows a cross-section through a half of a heat shield element 1 with an alternative embodiment of the cooling ducts 11C compared to FIG. 5. The cooling medium K, which is introduced into the inlets 13 of the cooling ducts 11C by the distribution system 9, flows from the first side area 17 along the wall requiring cooling 3 in the direction of the second side area 19. In the second side area 19 the cooling ducts make a U-turn 21. Here, the cooling medium K changes its direction of flow for the first time. When the cooling ducts 11C once again reach the first side area 17, they reverse direction once more and at this point make a second U-turn 21. In this way ducts lying adjacent to one another are flowed through in opposite directions, with the result that a counter flow of cooling medium K is generated. The outlets 15 of the cooling ducts 11C are in this case disposed in the second side area 19.

With a serpentine embodiment of the cooling ducts (11B, 11C) it is possible for the inlets 13 and outlets 15 of the cooling ducts 11B to be disposed in the same side area, or for the inlets 13 to be disposed in the first side area 17 and the outlets 15 to be disposed in the second side area 19. In this arrangement both configurations make at least one U-turn 21 and in this way a counter flow of cooling medium K is generated. Depending on the cooling requirements, a plurality of U-turns 21 can therefore be provided in order to achieve a serpentine cooling structure. Different cooling arrangements are also possible wherein the rectilinear cooling ducts 11A and the serpentine cooling ducts 11B and 11C are combined with one another in a heat shield element 1.

To sum up, it can be emphasized in particular that the present invention proposes novel and particularly efficient cooling of a heat shield element. The basic idea here is that cooling ducts are provided within the heat shield element wall requiring cooling. By this means the wall, to which hot medium is applied during operation, can be convectively cooled very effectively. The convective cooling which is achieved in the wall itself ensures on the one hand a very efficient use of cooling medium and on the other hand a very even temperature distribution on the wall requiring cooling. Furthermore, by means of the adjustable impingement cooling of the end of the feed duct, an additional cooling effect is achieved in the particularly critical areas of the heat shield element. In addition, a suitable heating of the cooling medium is achieved here before it flows to the cooling ducts.

1.-20. (canceled)

21. A heat shield element, comprising:
a wall with a hot face for the application of a hot medium;
a cold face opposite to the hot face;
a distribution system for a cooling medium assigned to the cold face; and
a plurality of cooling ducts in the wall along the hot face, wherein the cooling ducts are fluidically connected to the distribution system.

22. The heat shield element as claimed in claim 21, wherein the cooling ducts have an inlet and an outlet for the cooling medium.

23. The heat shield element as claimed in claim 22, wherein the wall has a first side area and a second side area located opposite to the first side area, and wherein the inlet of the cooling duct is disposed in the first side area and the outlet is disposed in the second side area.

24. The heat shield element as claimed in claim 21, wherein an inlet and an outlet of the cooling ducts are disposed in a first side area of the wall.

25. The heat shield element as claimed in claim 23, wherein at least on cooling duct has an U-turn in the second side area of the wall such that during cooling ducts adjacent to one another and connected via the U-turn are flowed through in opposite directions.

26. The heat shield element as claimed in claim 25, wherein the cooling duct is serpentine in shape.

27. The heat shield element as claimed in claim 22, wherein the cooling ducts are disposed closer to the hot face than to the cold face of the wall.

28. The heat shield element as claimed in claim 27, wherein the distance of the cooling ducts from the hot face amounts to between 20% and 40% of a thickness of the wall.

29. The heat shield element as claimed in one of claims 21, wherein the distribution system is mounted directly on the cold face of the wall.

30. The heat shield element as claimed in claim 21, wherein a retaining bolt has a retaining aperture surrounded by a plurality of feed ducts and a seal, wherein the cooling medium is supplied via the feed ducts.

31. The heat shield element as claimed in claim 22, wherein the outlet of a cooling duct is mounted on the cold face.

32. The heat shield element as claimed in claim 21, wherein the heat shield element consists of a high-temperature-resistant metal or metal alloy.

33. The heat shield element as claimed in claim 32, wherein a length of the heat shield element from an outer edge of the first side area to an outer edge of the second side area is between 200 mm and 400 mm.

34. The heat shield element as claimed in claim 33, wherein an impingement cooling of a part of the heat shield element is effected in the feed duct by the cooling medium.

35. A combustion chamber, comprising:
a supporting structure on which a plurality of heat shield elements are mounted, wherein the heat shield element has:
a wall with a hot face for the application of a hot medium,
a cold face opposite to the hot face,
a distribution system for a cooling medium assigned to the cold face, and
a plurality of cooling ducts in the wall along the hot face, wherein the cooling ducts are fluidically connected to the distribution system.

36. The combustion chamber as claimed in claim 35, wherein the heat shield element is fixed to the supporting structure via a retaining bolt.

37. The combustion chamber as claimed in claims 35, wherein the supporting structure has at least one feed duct to supply the cooling medium to the heat shield element via the feed duct.

38. The combustion chamber as claimed in claim 37, wherein the feed duct leads into the distribution system.

39. A gas turbine system, comprising:
a combustion chamber having:
a supporting structure on which a plurality of heat shield elements are mounted, wherein the heat shield element comprises:
a wall with a hot face for the application of a hot medium,
a cold face opposite to the hot face,
a distribution system for a cooling medium assigned to the cold face, and
a plurality of cooling ducts in the wall along the hot face, wherein the cooling ducts are fluidically connected to the distribution system.

40. The gas turbine system as claimed in claim 39, wherein from a compressor cooling air is tapped for cooling the combustion chamber.
